(19) United States
(12) Patent Application Publication
(10) Pub. No.: US 2024/0022343 A1
(43) Pub. Date: Jan. 18, 2024

(54) Emergency Response System and Method

(71) Applicant: ARKE AERONAUTICS LLC, Mt. Laurel, NJ (US)

(72) Inventors: Brandon T. Graham, Point Pleasant, NJ (US); Sherman Hartman, JR., Mullica Hill, NJ (US); Jonathan Penera, Mount Laurel, NJ (US); John Stranahan, JR., Glassboro, NJ (US); Benny Liang, Richland, NJ (US)

(21) Appl. No.: 17/866,072

(22) Filed: Jul. 15, 2022

Related U.S. Application Data
(60) Provisional application No. 63/222,109, filed on Jul. 15, 2021.

(51) Int. Cl. H04H 20/59; H04W 4/90; H04W 4/024; H04W 4/06; H04W 76/50; G01C 21/36; B64C 39/02

(52) U.S. Cl. CPC H04H 20/59; H04W 4/90; H04W 4/024; H04W 4/06; H04W 76/50; G01C 21/3691; B64C 39/024; B64U 2201/20

(57) ABSTRACT

The present disclosure describes emergency response system and method. In an aspect, when an emergency incident occurs and is reported, the emergency response system and method provides on a user device of a first responder, a map that at least include the location of an emergency incident; marks on the map, location of the incident, location of the first responder, and pre-plan information; and receives a live data stream and providing the live data steam on the user device of the first responder. It provides mobile first responders with enhanced situational awareness during the emergency. Information acquired through various sources may be organized and provided to parties such as dispatchers, incident commander, chief/officers and first responders.

### TECHNICAL FIELD

The application relates to the field of emergency service and more particularly relates to the field of managing and dispatching first responders.

### BACKGROUND

Emergency response systems in the modern society can reduce or prevent premature death and injuries and property damages caused by emergency incidents such as car crashes and fires, and thus affect every single person's quality of life. In the event of emergencies, time is of essence. For example, in the United States, about 700,000 people dialed 911, the national emergency number over every 24 hours. It takes approximately nine minutes after dialing for first responders to arrive on the scene. If this response time were to be reduced by just one minute, up to 10,000 lives could be saved as a result. In addition, not only must a first responder be able to arrive at an incident quickly, but the right type of emergency responder must be dispatched to deal with the special circumstances.

Computer-aided dispatcher (CAD) systems are known in the art to dispatch first responders. However, there are many drawbacks in the prior emergency response systems. For example, existing emergency response systems do not allow first responders to access information effectively, which may be developing and changing rapidly. First responders usually are not able to know the situation of the incident before they arrive on scene. First responders often are required to check in with the emergency dispatcher or with each other to report their locations and status on a regular basis via radio.

There exist needs for a solution for an emergency response system and method to provide an enhanced and rapid situational awareness and to elevate the capability of first responders with a convenient user-friendly interface.

### SUMMARY

Embodiments of the present invention provide an emergency response system and method with enhanced situational awareness, automated and rapid emergency response, and user-friendly interface.

According to one aspect of the present invention, an emergency response method, implemented by at least one computing system, comprises: providing on a user device of a first responder, a map that at least include the location of an emergency incident; marking on the map, location of the incident, location of the first responder, and pre-plan information; and receiving a live data stream and providing the live data steam on the user device of the first responder. The pre-plan information may include at least one from the group consisting of: location of hydrants, location of hazmat, and floor plan of buildings. The live data stream comprises at least one from the group consisting of: weather information, video feed from a camera in CCTV, video feed from a drone, output from a senor equipped with the first responder, location of other responder, location of an emergency vehicle.

According to the one aspect of the present invention, the emergency response method may further comprise: receiving an incident information indicating an occurrence of the emergency incident; sending a notification to the first responder's device about the occurrence of the emergency incident; receiving a response from the mobile device indicating if the first responder is available.

According to the one aspect of the present invention, the incident information may be entered by an emergency call center when receiving an emergency call from a caller; and the emergency response method may further comprise: sending a text message to the caller's device with a webpage link to upload caller video feed; receiving the caller video feed from the caller's device the video feed; and providing the caller video feed as a part of the live data stream.

According to the one aspect of the present invention, the emergency response method may further comprise: broadcasting a message with information about the incident to all cell phones near a location of the emergency incident.

According to the one aspect of the present invention, the emergency response method may further comprise: presenting a message with information about the incident to a signage near a location of the incident.

According to the one aspect of the present invention, the emergency response method may further comprise: providing navigation and routing to the location of the incident on the map.

According to the one aspect of the present invention, the emergency response method may further comprise: providing a control panel to control a drone to approach a location of the incident if the drone is available.

According to another aspect of the present invention, an emergency response system comprises: a computing device connected to a network; and a user device connected to the network; wherein the computing device comprises at least one processor and memory coupled to the at least one processor, the memory comprising computer executable instructions that, when executed by the at least one processor, performs a method comprising: providing on the user device of a first responder, a map that at least include the location of an emergency incident; marking on the map, location of the incident, location of the first responder, and pre-plan information; and receiving a live data stream and providing the live data steam on the user device of the first responder. The pre-plan information may include at least one from the group consisting of: location of hydrants, location of hazmat, and floor plan of buildings. The live data stream may comprise at least one from the group consisting of: weather information, video feed from a camera in CCTV, video feed from a drone, output from a senor equipped with the first responder, location of other responder, location of an emergency vehicle.

In another aspect of the invention, the method performed by the computing device may further include elements similar to those according to the one aspect of the invention.

### BRIEF DESCRIPTION OF DRAWINGS

The foregoing summary, as well as the following detailed description of the preferred embodiments, will be better understood when read in conjunction with the appended drawings. It should be understood, however, that the invention is not limited to the precise arrangements and instrumentalities shown. In the drawings,

FIG. 1 illustrates an embodiment of a computing system environment in which an embodiment of the invention may be implemented;

FIG. 2 illustrates an embodiment of a network environment in which an embodiment of the present invention may be implemented;

FIG. 3 illustrates an example of multi-tier client server architecture in which an embodiment of the invention may be implemented;

FIG. 4 illustrates a block diagram depicting the structure of the emergency response system according to the first embodiment of the present invention;

FIG. 5 illustrates a flow chart describing the data fusion routine when an emergency incident occurs according to the first embodiment of the present invention;

FIG. 6 is an exemplary user interface with a notification sent to a mobile phone of a first responder according to the first embodiment of the present invention;

FIG. 7 is an exemplary user interface of the incident dashboard provided to users of the emergency response system according to the first embodiment of the present invention;

FIG. 8 illustrates a user roles and structure diagram according to the first embodiment of the present invention;

FIG. 9 illustrates primary services that the emergency response system according to the second embodiment of the present invention provides;

FIG. 10 illustrates a flow chart of an emergency response routine performed by the emergency response system according to the second embodiment of the present invention.

FIG. 11 illustrates a data flow chart of the emergency response system according to the second embodiment of the present invention; and

FIG. 12 illustrates a data flow chart of the emergency response system according to the third embodiment of the present invention.

### DETAILED DESCRIPTION

A preferred embodiment will be set forth in detail with reference to the drawings, in which like reference numerals refer to like elements or steps throughout.

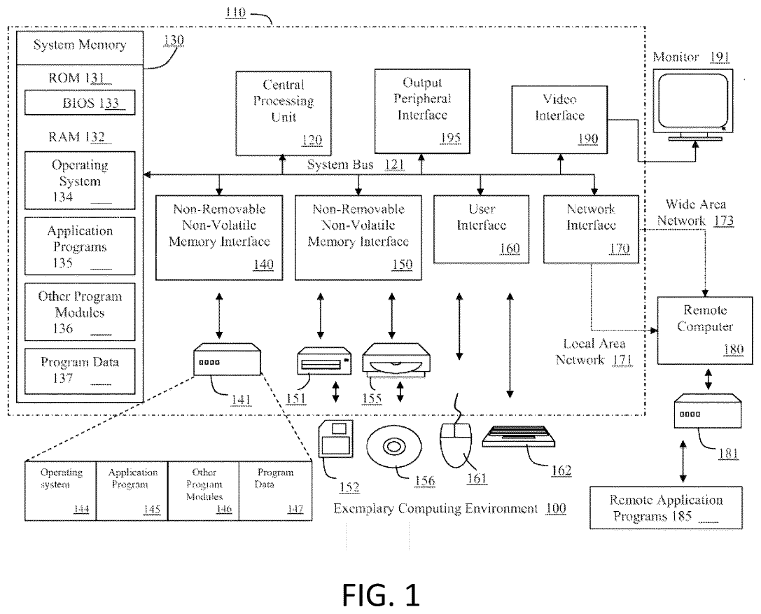

Below, examples of computing system, network environment, and client-server environment in which the embodiments of the present invention may be implemented are described by referring to FIGS. 1-3.

### Example Computing Environment

FIG. 1 and the following discussion are intended to provide a brief general description of a suitable computing environment in which an example embodiment of the invention may be implemented. It should be understood, however, that handheld, portable, and other computing devices of all kinds (e.g., smartphones, tablets, and laptops) are contemplated for use in connection with the preferred embodiment. While a general-purpose computer is described below, this is but one example. The preferred embodiment also may be operable on a thin client or mobile device having network server interoperability and interaction. Thus, an example embodiment of the invention may be implemented in an environment of networked hosted services in which very little or minimal client resources are implicated, e.g., an app or a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well-known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which an embodiment of the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or a combination of components illustrated in the exemplary operating environment 100.

With reference to FIG. 1, an example system for implementing the invention includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus (also known as Mezzanine bus), and PCI-Express bus.

The computer 110 typically includes a variety of computer readable media. Computer readable media can be any available media that can be accessed by the computer 110 and include both volatile and nonvolatile, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, solid state drives (SSD), or any other medium which can be used to store the desired information and which can be accessed by the computer 110. Communication media typically contain computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and or program modules that are immediately accessible to and/or presently being operated on by the processing unit 120. By way of example, and not limitation, FIG. 1 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical medium. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, the hard disk drive 141 is illustrated as the storing operating system 144, application programs 145, other program modules 146, and program data 147. Note that these components can either be the same as or different from the operating system 134, application programs 135, other program modules 136, and program data 137. Operating system 144, application programs 145, other program modules 146, and program data 147 are given different numbers here to illustrate that, at a minimum, they are different. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121 but may be connected by other interface and bus structures, such as a parallel port, game port or a universal serial bus (USB).

A monitor 191 or other type of display device is also connected to the system bus 121 via an interface, such as a video interface 190. In addition to a monitor 191, computers may also include other peripheral output devices such as speakers and a printer (not shown), which may be connected through an output peripheral interface 15.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections illustrated in FIG. 1 include a local area network (LAN) 171 and a wide area network (WAN) 173, hut may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes means for establishing communications over the WAN 173, such as the Internet, hi a networked environment, program modules illustrated relative to the computer 110, or portions thereof, may be stored in the remote memory storage device. By way of example, and not limitation, FIG. 1 illustrates remote application programs 185 as residing on a memory device 181. Remote application programs 185 include, but are not limited to, web server applications such as Microsoft® Internet Information Services (ITS)® and Apache HTTP Server which provides content which resides on the remote storage device 181′ or other accessible storage device to the World Wide Web. It will be appreciated that the network connections shown are exemplary and other means of establishing a communications link between the computers may be used.

One of ordinary skill in the art can appreciate that a computer 110 or other client devices can be deployed as part of a computer network. In this regard, the preferred embodiment pertains to any computer system having any number of memory or storage units, and any number of applications and processes occurring across any number of storage units or volumes. An embodiment of the present invention may apply to an environment with server computers and client computers deployed in a network environment, having remote or local storage. The preferred embodiment may also apply to a standalone computing device, having programming language functionality, interpretation, and execution capabilities.

### Example Network Environment

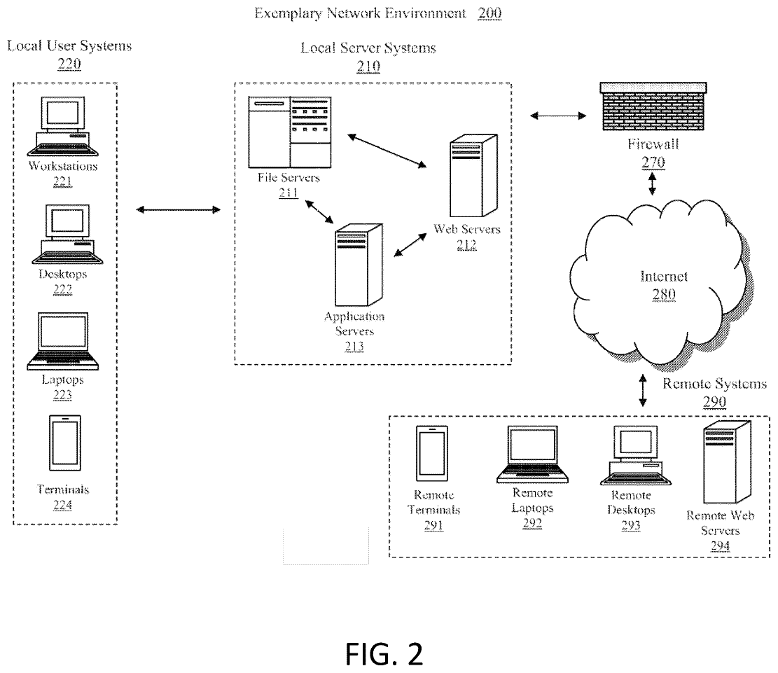

FIG. 2 illustrates an embodiment of a network environment in which an embodiment of the present invention can be implemented. The network environment 200 contains a number of local server systems 210, which may include a number of file servers 211, web servers 212, and application servers 213 that are owned and managed by the owner of the local network.

These servers are in communication with local user systems 220 which may include a large variety of systems such as workstations 221, desktop computers 222, laptop computers 223, and thin clients, smartphones, tablets, or terminals 224. The local user systems 220 may contain their own persistent storage devices such as in the case of workstations 221, desktop computers 222, and laptop computers 223. They can also have access to the persistent storage, such as a database, provide by the local servers 210. In the case of thin clients and terminals 224, network storage may be the only available persistent storage. The users within the local network usually get access to the wider area network such as the Internet 280 though the local server systems 210 and typically some network security measures such as a firewall 270. There might also be a number of remote systems 290 that can be in communication with the local server systems 210 and also the local user systems 220. The remote computer systems can be a variety of remote terminals 291, remote laptops 292, remote desktops 293, and remote web servers 294. FIG. 2 illustrates an exemplary network environment. Those of ordinary skill in the art will appreciate that the teaching of the present invention can be used with any number of network environments and network configurations.

Client-Server Environment

The client-server software architecture model is a versatile, message-based and modular infrastructure that is intended to improve usability, flexibility, interoperability, and scalability as compared to centralized, mainframe, time sharing computing. Client-server describes the relationship between two computer programs in which one program, the client is defined as a requester of services, which makes a service request from another program, the server is defined as the provider of services, which fulfills the request. A client-server application is a distributed system comprised of both client and server software. A client software process may initiate a communication session, while the server waits for requests from any client.

In a network, the client-server model provides a convenient way to efficiently interconnect programs that are distributed across different locations. Transactions among computers using the client-server model are very common. Most Internet applications, such as email, web access and database access, are based on the client-server model. For example, a web browser is a client program at a user computer that may be used to access information at any web server in the world. For a customer to check a bank account from a remote computer, a client program, which may run within a web browser, forwards a request to a web server program at the bank. The web server program may in turn forward the request to a database client program that sends a request to a database server at another bank computer to retrieve the requested account balance information. The balance information is returned back to the bank database client, which in turn serves it back to the web browser client in the customer's computer, which displays the information to the customer.

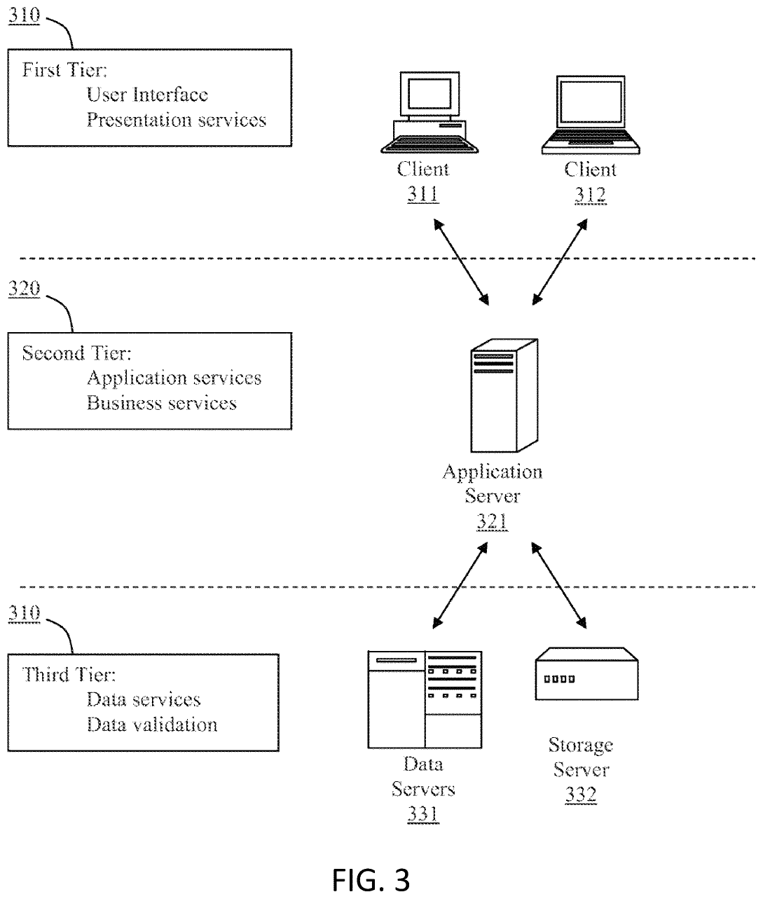

FIG. 3 illustrates an example of multi-tier client server architecture. Multi-tier client-server architecture allocates different tasks and services to different tiers. In the example multi-tier architecture of FIG. 3, there are three logical tiers. The first tier 310 is one or more clients 311, 312, the second tier is an application server 321, and the third tier 330 is a data server 331 332. At the client tier, the clients 311, 312 provide the application's User interface and also act as presentation servers. The application's graphical user interface is generally a custom-generated web page to be displayed by a web browser on the client computer. There can be one or more application servers 321 that host the business logic, and one or more data servers 331, 332 to provide data storage and validation services. The main body of an application is run on a shared host 321. The application server 321 does not drive the graphical user interface, rather it shares business logic, computations, and a data retrieval engine. The presentation of data retrieved is handled by the presentation server at the client tier. With less software on the client systems, there are fewer security concerns. Application scalability, support costs, and installation costs are all more favorable when the software is concentrated on a single server than when the software is distributed amongst a number of desktop clients.

The client-server architecture in the network environment also makes cloud computing possible. Specifically, cloud computing is the on-demand availability of computer system resources, especially data storage (cloud storage) and computing power, without direct active management by the user. Commercially available examples of cloud computing service include Amazon Web Services and Microsoft Azure.

In the embodiments of the present invention, the emergency response system and method provide an easy-to-use tool managing emergency incidents and dispatching first responders. The emergency response system and method are designed to be implemented by at least one computing system, an example of which is shown by FIG. 1 and discussed above, in a network environment, an example of which is shown by FIG. 2 and discussed above. The emergency response system and method may also be implemented by a cloud computing system. The system and method for managing and dispatching first responders receive and output data from and to a user and multiple data sources in a client-server environment, an example of which is shown by FIG. 3 and discussed above. In the embodiments of the present invention, when the emergency response system and method receive and output data from and to a user, the emergency response system and method may be implemented as the server side, while the user may use a terminal or a computing system as the client side. On the contrary, when the emergency response system and method receive and output data from and to other data sources, the system and method for managing and dispatching first responders may be implemented as the client side.

### First Embodiment

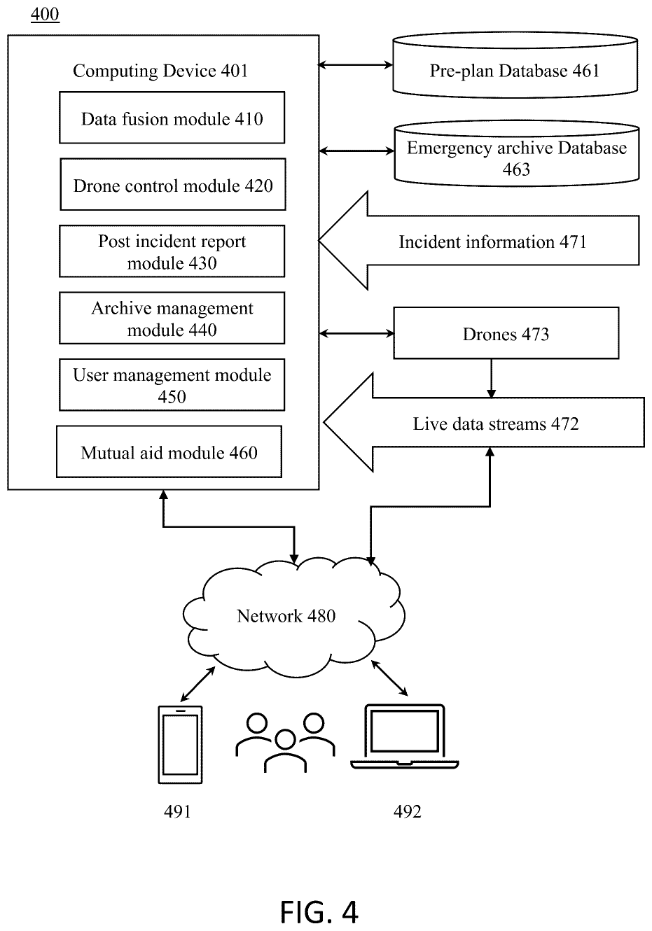

FIG. 4 is a block diagram illustrating the structure of the emergency response system 400 according to the first embodiment of the present invention. As shown by FIG. 4, the emergency response system 400 includes a computing system 401, which in turn comprises at least one processor and memory coupled to the at least one processor (not shown in the figure). The computer system 401 further comprises data fusion module 410, drone control module 420, post incident report module 430, archive management module 440, and user management module 450 that can be embodied as computer readable instructions stored in the memory. The emergency response system 400 also connects to end users through network 480. End users may include first responders, dispatchers, incident commanders, and other officers that are allowed to access the system 400, and may also include community residents, commercial property owners, fire inspectors, callers who contact the emergency call center, among others. End users may access the system 400 through mobile devices 491 such as smart phones or tablets or computer devices 492 such as desktop computers and laptops.

The emergency response system 400 may further comprise a pre-plan database 461 and an emergency archive database 462. Either database can be stored on the local storage of the computing device 401 or on a remote data server to be accessible by the computing device 401 through network. The pre-plan database 461 comprises pre-plan information that includes characteristics about buildings, locations, or areas that may help inform emergency responders before and during a response. For example, the pre-plan information includes location and characteristic information about hydrant, fire department connection (FDC), and hazmat information such as safety data sheet (SDS) or formerly material safety data sheets (MSDS). A fire hydrant is a connection point by which firefighters can tap into a water supply. It is a component of active fire protection. FDC is part of a fire sprinkler system or standpipe system consisting of an inlet and pipe system that enables a responding fire department to supplement a fire sprinkler system's water supply. Hazmat can include explosives, flammable and combustible substances, poisons, and radioactive materials. Emergencies can happen during production, storage, transportation, use or disposal of hazmat. The information contained in the SDS is largely the same as the MSDS, except now the SDS's are required to be presented in a consistent user-friendly, 16-section format. The SDS includes information such as the properties of each chemical; the physical health, and environmental health hazards; protective measures; and safety precautions for handling, storing, and transporting the chemical.

Emergency archive database 462 includes information for manage emergency activities such as calls and responses. A “Call” refers to telecommunication from the 911 caller to dispatcher or the dispatcher to the appropriate department or personnel. Responses are manufactured terms used to correlate and store all relevant activities performed in response to a Call in the order in which they were executed. These activities might consist of users indicating their response status, GPS positions of users at a given time, or who was on scene during the incident, and may further include all the raw live data that were input to the system 400. Emergency archive database 462 may also help users to create post-incident report.

In addition, the emergency response system 400 may connect to the drones 473. The drones 473 may be arranged in stations that are distributed in the area that the emergency response system 400 oversees or equipped on emergency vehicles. The drones 473 are equipped with a camera. When an emergency incident occurs, these drones may be deployed under instructions of the first responders to the incident scene and return video feeds at and around the incident scene.

As shown in FIG. 4, the computing device 401 also received data input such as the incident information 471 and live data streams 472. The incident information 471 is an information input as an intriguer to start an emergency response in the system 400. The incident information can be an incident notice from 911 call center dispatcher, an incident notice from an existing CAD system (which may be in turn triggered by 911 call center dispatcher), and an incident notice manually initiated by an authorized department or a dispatcher.

In addition, live data streams 472 are data from sources that update the data frequently or in real time. Live data can inform or help accelerate decision making during a response. Live data may include, for example, weather/wind conditions at the time of the response, live video from CCTV camera close to the scene, live video from drones that are dispatched, live video/live status information from the camera and sensors worn by the first responders, live video/audio uploaded by the 911 caller or bystander through their mobile devices.

Below, the function of each module in the emergency response system 400 will be described by referring to the drawings.

Data Fusion Module

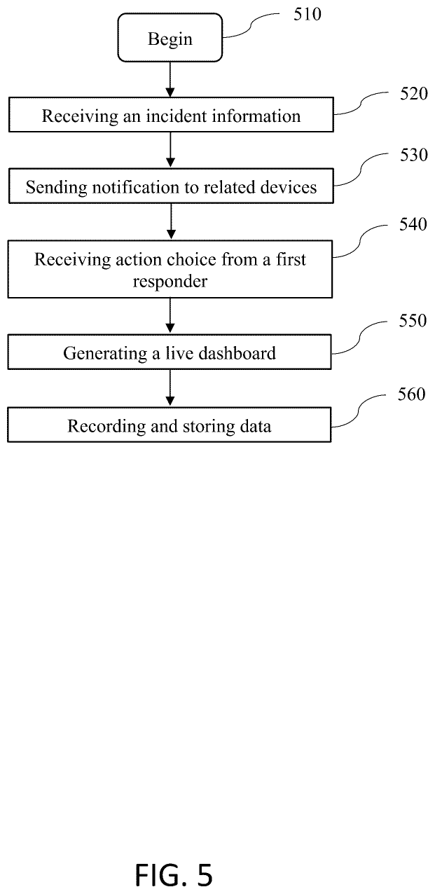

FIG. 5 depict a flow chart describing the data fusion routine when an emergency incident occurs and the system 400 responses through the data fusion module 410. The data fusion routine is the main routine run in response to an emergency incident. It will take information from multiple sources, organize it, and make it accessible for use during emergency management and first response. This data will be provided in a meaningful way, which will enhance the safety and security of the emergency response network during operations.

As shown in FIG. 5, at step 520, the data fusion module 410 is activated by receiving the incident information 471. As aforementioned, the incident information 471 may come from a plurality of sources, and it can be an incident notice from 911 call center dispatcher, an incident notice from a current CAD system (which may be in turn triggered by 911 call center dispatcher), and an incident notice manually initiated by an authorized department or a dispatcher. In practice, an incident notice manually input from a department officer, or a dispatcher is usually a test or response drill. In one embodiment, the emergency response system 400 may include an API that is compatible with existing systems at 911 call center or current CAD systems to receive incident notice from the corresponding systems. It allows the emergency response system 400 to be adapted without substantially altering existing systems. In addition, or alternatively, the emergency response system may also connect directly with 911 call center. The emergency response system 400 may further include an API that allows an authorized department officer or dispatcher to send an incident notice through a client application, web browser, or even emails or text messages. In one embodiment, the incident notice follows a specific format to indicate the incident information such as location, incident type, contact information, among others. In another embodiment, the incident notice may be written in natural language and sent via email or text messages and recognized by the data fusion module 410 of the incident information through AI enhanced algorism.

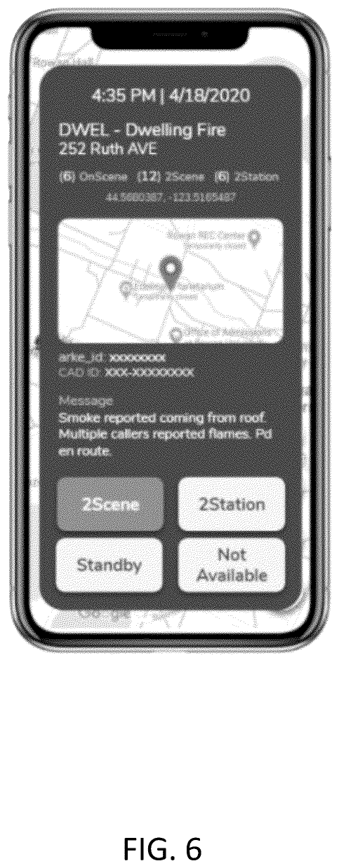

The routine then goes to steps 530 and 540. At step 530, the data fusion module 410 sends a notification to each relevant user's device, such as a mobile phone or tablet of a first responder, and a department computer of an officer or dispatcher. In one embodiment, the data fusion module 410 sends notifications based on the location and type of the incident. For example, if the incident notice reports a fire, the notification will be pushed to the user devices of related fire department or fire station that oversees the specific area in which the fire incident happened and to the mobile devices of related fire fighters. As for the incident notification sent to a first responder, the first responder may review basic information of the incident such as location and type of the incident and make an initial response. As for the incident notification sent to a department device, a response is not necessarily required. FIG. 6 depicts an exemplary notification sent to a mobile phone of a first responder according to the first embodiment of the present invention. As shown in FIG. 6, the notification includes time, location, and description of the emergency incident. The notification also prompts the first responder to choose an initial response from a few options: going to the incident scene, going to the station, standby, and not available. Once a first responder has made a choice, the choice will be sent to the emergency response system 400.

The routine then goes to step 550. Based on the action choice of the first responder, the data fusion module 410 will provide accessibility of a live incident dashboard to the first responder. For example, when the first responder choses the option of going to the station, going to the scene, or standby, the data fusion module 410 may then provide a live dashboard to the first responder. As for the department device, the live incident dashboard may be provided without requiring the officer or dispatcher to choose an initial response.

The data fusion module 410 generates a live dashboard that presents data and information related to the incident to its users such as a first responder, an incident commander, a department/station office, etc. For example, the data fusion module 410 may retrieve map information from public available sources, such as google map, or proprietary sources, so as to get maps, street views, building floor plans around the incident scene and around the first responders. The data fusion module 410 may also retrieve SDS and MSD with information about hydrant, hazmat, etc. from the pre-plan database 461. The data fusion module 410 may further obtain weather information from public weather data sources. In addition, the data fusion module 410 may get updates from 911 response data through existing systems such as CAD system as aforementioned, obtain CCTV video feeds around the incident scene, video/audio/location information from the sensors equipped on the first responders and vehicles. When there is a drone station around the incident scene or a drone station on an emergency vehicle and a drone is released, the data fusion module 410 may also obtain the video feed and location information from the drone. The data fusion module 410 may aggregate all those data and information and push and present those data in a user-friendly interface to related first responders and other users such as an incident commander and officer. Furthermore, the data fusion module 410 may also suggest a route for the first responder to get to the scene, station, or a location selected by the first responder on the map.

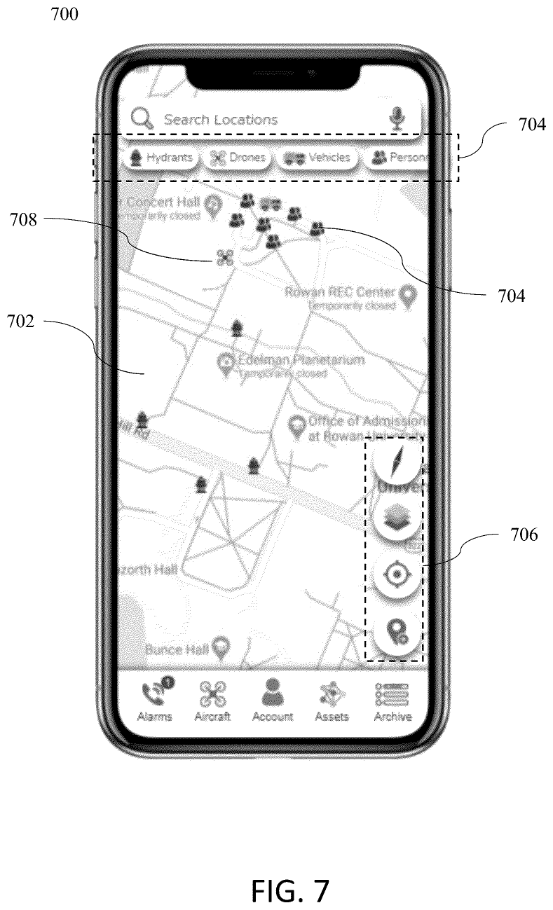

FIG. 7 depicts an exemplary user interface 700 of the dashboard provided to users of the emergency response system 400 during an emergency incident. As shown in FIG. 7, the user interface 700 is shown as a map 702 with related information indicated on and surrounding the map. As show by the map legends 704, hydrants, drones, vehicles and first responders are shown as symbols on the map, which reflect their real-time locations. In other embodiments, other related information, such as hazmat, CCTV cameras may be indicated by symbols on the map. On the left bottom side of the map, there are operation buttons 706 for the user to find his or her own location, to have satellite map shown, etc. The user may zoom in and out or move the center of the map by pinch or swipe on the map.

In one embodiment, if the user touches or clicks the symbols on the map, relative information will be further provided. For example, if the user clicks a hydrant on the map, information such as its precise location may be prompted. If the user clicks a person on the map, which is usually another first responder, information related to the responder may be promoted, for example, name, contact information, data from the sensors worn by the first responder, etc. If the user clicks on a drone, the video feed of the drop may be provided. In some embodiments, based on the authorization of the user, the user interface 700 may further provide a control panel for the user to control and maneuver the drone. In some embodiments, the user may also check CCTV video feed, weather information, floor plan of buildings on the map, among others.

As shown at the bottom of FIG. 7, some other functions of the emergency respond system 400 are listed, such as drone control, incident archive, user management. During a life span of an incident, the first responder may also check available drones of which the incident scene is in the range by clicking or touching the “Aircraft” button. The first responder may then choose to deploy a selected drone. Once a drone is deployed, the first responder may control the drop through the user interface 700. Many commercially available drones offer API to control the drone and plan a route to the destination. Therefore, the emergency response system 400 may also autonomously maneuver the drone to the incident scene through the drone control module 420, which will be described in detail later. The released drone will also feed its location and video to the data fusion module 410 as a part of the live data streams 472 as shown in FIG. 4. As shown in FIG. 7, an icon corresponding to the deployed drone will also be present on the incident dashboard at the corresponding location on the map 702. As aforementioned, a user that is being fed the incident dashboard may view the video by clicking or touch the corresponding icon 708 on the map 702.

In one embodiment, the dashboard provided to users may be customizable based on the user authorization. In this case, users are categized into various groups. For example, a incident commander may be able to check the location, detailed information, data of wearable sensors of all the first responder that are related to an incident (standby, going to the scene, or going to the station) while a first responder may be authorized to check location of other first responders but not their detailed information. User management will be discussed later.

As shown by step 560, the data fusion module 410 records and stores all the data received during the life span of an emergency incident together with time stamp, including incident information, notification, and actions taken by each of the first responders in the emergency response system, data gathered during the incident life span such as map information, video feeds, data from sensors on vehicles and first responders. Those data will eventually be saved to the incident archive database 463 and may be replayed in chronological order on the timeline of the incident, which will be described later regarding the archive management module. In addition, the step 560 is shown in FIG. 5 to be executed after the live dashboard is generated. However, the step 560 may also run in the background throughout lifespan of the routine and keep recording and storing all the date related to the actions taken and information received.

Through data fusion module 410, the emergency response system 400 may connect first responders to critical information on their devices especially their cell phones and tablets before they arrive on scene. The data fusion & common operating module works by combining and sharing multiple information streams in real-time including but not limited to computer-aided dispatch, building floor plans, personnel locations, live video feed from drones and CCTV, and weather information. The data fusion & common operating module may also have API that may be potentially connected to other data/information sources. data fusion & common operating module sends instant notifications with customized response dashboards, to help first responders receive information promptly, make informed decisions, and arrive on-scene faster.

Post Incident Report Module

Post incident report module 430 is configured to generate an incident report after the emergency incident has been handled. In one embodiment, the post incident report module 430 may generate a standardized incident report automatically based on a format that is required during the ordinary operation of a specific department, station, or office, by selecting the information that is known and obtaining when the incident is reported and handled and arranging the information in a required format. For example, the post incident report module 430 may generate a standard National Fire Incident Report to NFIRS (National Fire Incident Report System) as required by Federal Emergency Management Agency. The post incident report module 430 may also generate a report that is standardized for internal use based on a template with predetermined format and predetermined information. In another embodiment, the post incident report module 430 may also allow a user to customize an incident report by allowing the user to choose the information to be shown, and the format and arrangement of the information on the report.

Post incident report module 430 may further comprise a Review & Approve component. Based on the workflow of the department, an incident report automatically generated by the module 430 may be submitted to a corresponding first responder or an officer in the department for their review and edit. The incident report that has been thus reviewed may be in turn pushed to another first responder or officer for additional review and approval before finalized. Post incident report module 430 may access the user authorization data, as will be described below regarding user management, and push the assignment to relative users in accordance with the workflow of the department.

Archive Management Module

Archive management module 440 provides a tool for a user to view and manage past incidents. An authorized user is allowed to view the past incident. In one embodiment, the Archive management module 440 may provide a timeline viewer, through which a user may view the relevant activities in response to an emergency call in the order in which they were performed. In one embodiment, a slider bar corresponding to the timeline during the life span of an incident is provided. When the user moves the slider bar to a specific time point, activities, and status of the incident at the specific time point are shown. Those activities may include, for example, receipt of a call reporting the incident, initial response (action choice of “standby,” “go to the scene,” etc.) from the responders, location tracking of the responders, video feed from the devices of the responders, drone, or CCTV. The archive management module 440 may thus provide a user-friendly, visualized, and intuitional interface to replay the incident. It may also be used for training.

User Management

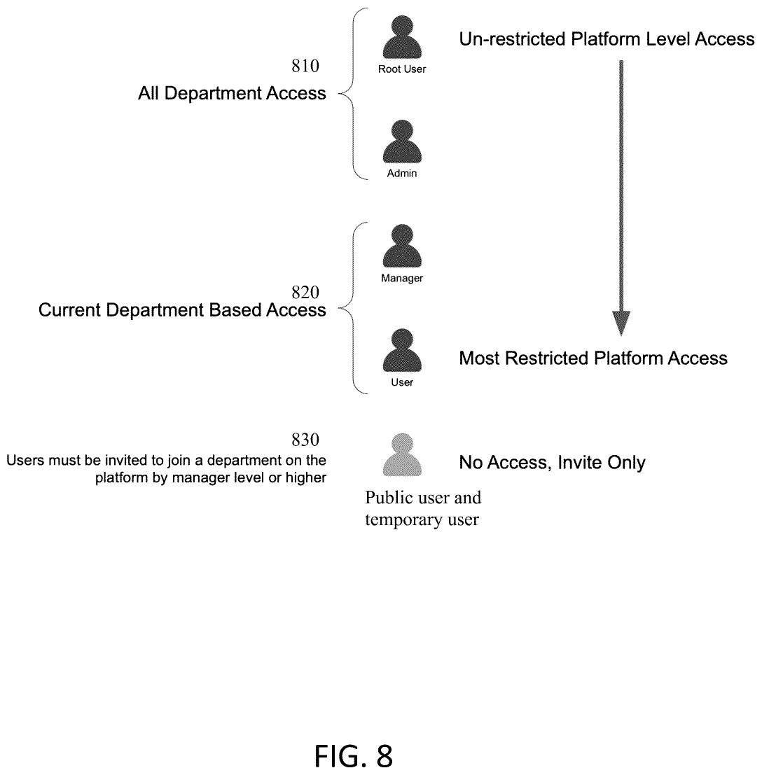

FIG. 8 depicts a user roles and structure diagram according to the first embodiment of the present invention.

As shown in FIG. 8, all the users may be roughly divided into three groups based on their accessibility of the emergency response system 400. User group 810 has un-restricted accessibility of the emergency response system 400. The users in the user group 810 include root users and admin users that are at a department and may access the dashboard of all ongoing incidents and operate the drones provided by the data fusion module 410, the past incident data through archive management module 440, generate and review incident report through post incident report module 430. The users in the user group 810 may also access user management module 450, to add, remove, or change information or accessibility of other users.

User group 820 may include managers or incident commanders and first responders. For example, manager or commander may have access to the dashboard of all ongoing incidents and may use incident report module 430 and archive management module 440. However, they cannot access user manage to add, remove, or change user data. A first responder user may be more restricted and may only access the dashboard of an ongoing incident which the user is involved. In another example, the functionality and information that are accessible to a first responder users may be further restricted. For example, first responders may be not allowed to operate a drone, while only incident commander or manager may operate a drone. In another example, a first responder user may also be granted a temporary access to modules and functionalities that are not open to him or her. For example, when responding to an incident, a commander user or admin user may grant a temporary authorization for a first responder user to operate a drone. After the incident is handled, a first responder may be granted a temporary authorization to generate an incident report.

User group 830 may include public and temporary users that are most restricted. For example, public users may be granted no access as default. In some cases, they may be granted a temporary access to some specific modules or functionalities. For example, during a 911 emergency call, the 911 dispatcher may request authorization of the caller to upload live video feed of the scene. If the caller accepts, a text with a link will be sent to the caller. Through that link, the caller is granted a temporary access to upload video feed to the data fusion module 410. In another example, a property manager may be allocated with a user account to update pre-plan information, for example, the floor plan of the property in the pre-plan database. In another example, when an incident requires cooperation from another department in an adjacent area, a commander user or an admin user may grant first responders from the other department a temporary access to the dashboard, and may also allow the devices from the other department to feed data to the data fusion module 410. In another embodiment, the authorization of each user may be individually configured.

Mutual Aid Module

Mutual aid module 460 provides API to connect to other emergency response networks which do not necessarily have the same system as the emergency response system according to the present invention. For example, when an incident requires involvement or reinforcement of first responders from another department, the mutual aid module 460 may allow first responders from the other department to access the live dashboard temporarily and upload live data stream from their mobile device, emergency response system or CAD. This can be done by, for example, sending a text message or email with a link to a webpage that allow temporary access, or login credential of the mobile or computer application to allow temporary access. The first responders and officer from the other department may then access the live dashboard including the incident information, maps, building floor plans and hazards locations, video feeds about the specific incident by simply opening the link in a webpage browser or downloading the application and logging in with the provided temporary credential. The first responders from the other department may be treated as a regular user of the emergency response system 400 in the life span of the specific incident. They may similarly update their location and action in the emergency response system 400 and upload video feeds from their mobile devices. In another embodiment, the emergency response system 400 may further access location and status information, building floor plans and other hazards from the other department, and even video feeds of drones and CCTV in control of the other department if the emergency system or CAD of the other department make them accessible by providing API to the emergency response system 400. When another department is dealing with an incident and may require data from providers that are accessible by the emergency response system 400, the emergency response system 400 may also allow their emergency response system or CAD to retrieve live data stream and pre-plan information. Therefore, the emergency response system 400 allows both platforms to periodically share those type of information and temporarily grant access to that information in the event of a mutual-aid assignment.

It can be understood that the emergency system 400 does not require all of the modules to function except the data fusion module. For example, in one embodiment, when there is no drone station in the area or the vehicles are not equipped with a drone, the drone control module 420 may be omitted. Depending on the needs of the emergency response network, post incident report module 420, archive management module 440 may also be omitted.

### Second Embodiment

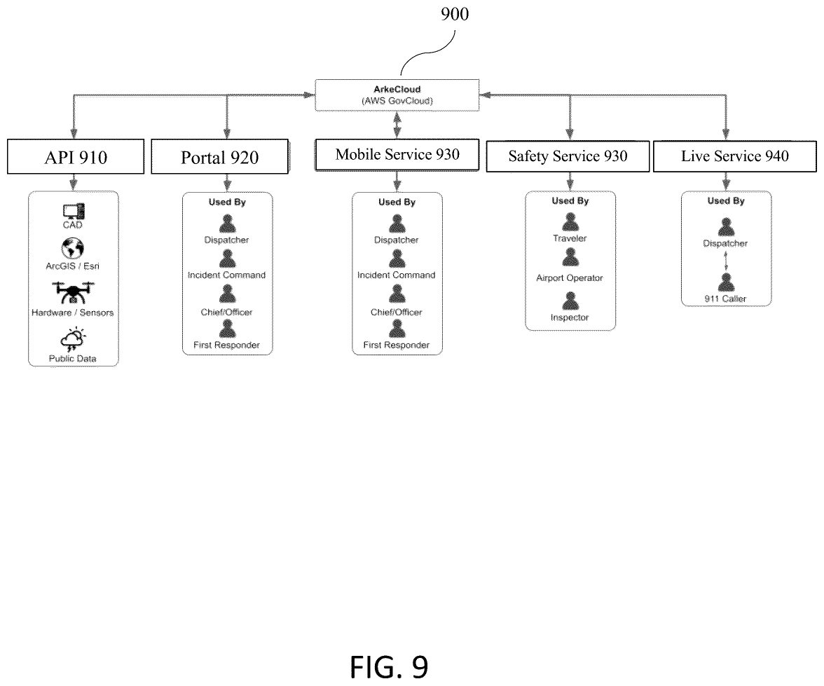

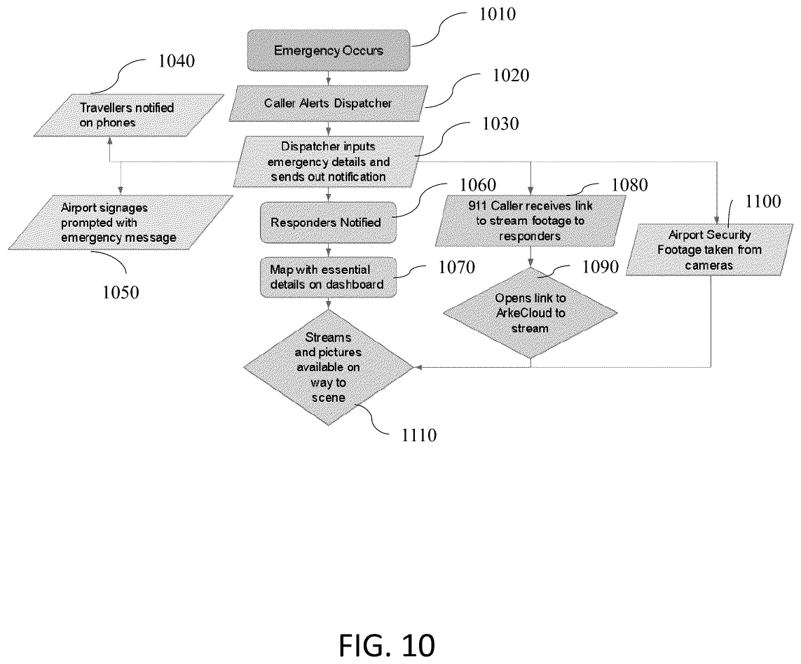

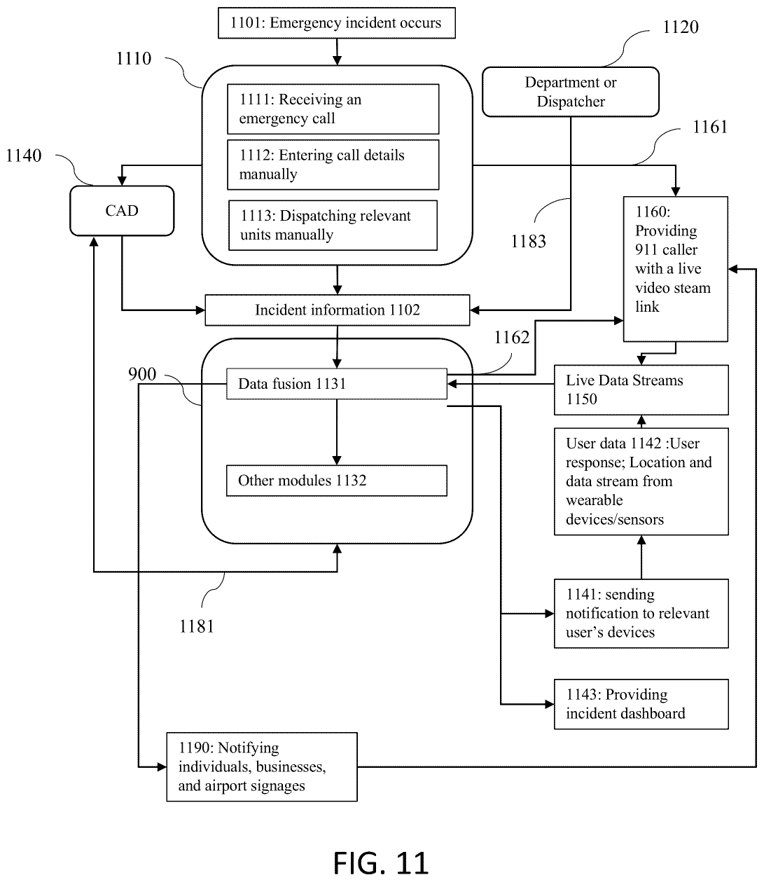

Below, the second embodiment in which the emergency response system and method is applied to an airport is described by referring to FIGS. 9-11. FIG. 9 depicts primary services that the emergency response system 900 according to the second embodiment provides. FIG. 10 depicts a flow chart of an emergency response routine performed by the emergency response system 900 according to the second embodiment. FIG. 11 depicts a data flow chart of the emergency response system according to the second embodiment. The emergency response system 900 may reduce the first response time by streamlining the emergency management process, allowing dangerous situations to be dealt with more effectively, increasing situation awareness to the passengers, and making the passengers feel safer and more secure.

As shown in FIG. 9, the emergency response system 900 according the second embodiment is a cloud-based platform built for emergency responses. The emergency response system 900, similar to the emergency response system 400 as shown in FIG. 4, includes a computing device that comprises data fusion module, drone control module, post incident report module, archive management module, and user management module that can be embodied as computer readable instructions stored in the memory. Therefore, the detailed description of the modules is omitted. FIG. 9 depicts the functional services that are categorized based on the target users.

User management portal 920 is used for configuring and managing a user's account and corresponds to user management module. System administrators or managers are able to edit their department's information, while users are able to access and modify their personal accounts within the system. User management portal 920 will be useful for parties such as dispatchers, incident commander, officers, and first responders to manage themselves and their departments. This service is provided through the user management module. As aforementioned, some users, such as system manager and officers, will be able to add, remove, and edit other user's information, such as dispatchers' and first responders'. Because the emergency response system is a secure platform, a user must be invited to join. To be invited, the user must be affiliated with an emergency department. To set up a new department, the manager identified will be invited to the platform by an administrator. Once they have created their account, they will send an email invitation to all necessary department users. Those users then create accounts, download the application, and enable notifications. The platform should then be ready for use. The manager of the department will be able to use the user management portal 920 to change any pertinent user details, or the department as a whole. Users other than administrator or manager will be able to update only their profiles.

Mobile service 930 is the primary end-user target of the platform and can be achieved through the data fusion module. It provides mobile first responders with enhanced situational awareness during the emergency. Information acquired through various sources will be organized and provided to parties such as dispatchers, incident commander, chief/officers and first responders.

Safety service 940 provides a channel through which passengers, airport employees, or local community members could assist in keeping the airport safe by proactively sharing information, which could potentially lead to an emergency being resolved before it even happens. For example, a property manager may update floor plans of the property through safety service 940.

Live service 950 allows an individual around the incident scene to feed live video to the system. For example, after an emergency is reported, the caller will be prompted to consent to allowing the emergency response system 900 to access their smartphone camera. By accessing the camera, live video feed of the emergency scene can be directly broadcasted to the platform. The 911 caller would not be required to download an app, they would simply receive a non-intrusive text message asking to allow or deny access while still on the phone with the 911 operator. Along with live video, the caller or passengers around the scene could provide audio, text, or images that would also be made available to the first responders and commander through the mobile service 940.

API 910 allows for seamless integration to the existing technology ecosystem by enabling two-way communication between the system 900 and approved third party services such as digital signage software, meteorological data, CCTV camera feeds, drones, among others.

FIG. 10 is a flow chart of the emergency response routine according to the second embodiment. As shown in FIG. 10, when an airport emergency occurs as indicated by the step 1010, call center dispatcher will receive alerts from a caller at step 1020. In the event of an airport emergency, 911 is the primary way the American public reports distress. Some airports will post emergency hotline numbers which go directly to the Airport Emergency Operations Center (“EOC”), however these are not always known by travelers in distress. This is often an issue for 911 call routing purposes as Airports often fall between multiple cell towers or response areas. Usually at airports or ports, depending on where the caller is in the airport, their call will be routed to the corresponding Public Safety Answering Point (“P SAP”) and then routed back to EOC, which may result in losing valuable time. On the contrary, the emergency response system 900 may operate autonomously in the background and compatibly with the existing computer-aided dispatch system at the call center. Therefore, when the call center dispatcher enters call information into the CAD at 1030, the emergency response system 900 will transmit a real time incident information to different recipients and units as indicated by the arrows extending from the step 1030.

As shown by steps 1060-1070, similar to the routine aforementioned by referring to FIG. 5, the emergency response system 900 will notify emergency personnel on their mobile devices and indicate exactly where the emergency is located, as well as the type and severity. Responders can indicate if they are on the way to the scene, on standby, or not available. They will then be presented with an incident dashboard that allows them to see the map and use in-app navigation and routing to arrive at scene. Locations and status of personnel are tracked, and response analytics are generated for incident commander in real-time. At step 1100, the system also uses video footage from security cameras and autonomous terrestrial robotic systems or even Unmanned Aviation Systems (UAS) on the airport campus relevant to the emergency at hand. The video would be accessible via first responders' while on the way to the scene. Additional relevant assets that can also be connected to the emergency response system 900 include IoT sensors to indicate heat, pressure, or other relevant properties, and geospatial software will indicate geographical data and meteorological data as needed.

As shown by step 1040, the emergency response system 900 also sends the notification to travelers, airport employees, and community members around the airport, on their phones. For example, the emergency response system 900 may send the incident information to mobile base stations in or around the airport, the mobile base stations will then broadcast the information as text messages to all the mobiles that are currently connected to the base stations. Therefore, all the individuals with a mobile phone will be receiving the notification and alerted about the incident. In addition, as shown by step 1050, the emergency response system 900 also connects to the signages in the airport and transmits the incident information to the signages, therefore, the airport signages may present emergency messages to the passengers in the airport.

As shown by steps 1080 and 1090, the call center dispatcher, during an emergency call, may also request authorization of the caller for the emergency response system 900 to access the camera on the caller's mobile device. If the caller agrees, the call center dispatcher may then send a text message with a webpage link to the caller's mobile device. By clicking on the link, the caller will be prompted to feed live video preferably through browser on their mobile device without having to downloading an application. In another embodiment, the link may also lead the caller to download an application to feed live video to the emergency response system, which may in turn be fed to dashboard on first responders' mobile devices.

FIG. 11 is a data flow chart showing in greater details how the information and data are transmitted when the emergency response system according to the second embodiment responds to an emergency incident.

In FIG. 11, a block with rounded corners refers to a system or entity, for example, call center 1110, a department/dispatcher 1120, the emergency response system 900, the existing computer-aided dispatcher system (“CAD”) 1140. A rectangular block refers to an information that is provided or an activity that is performed by those systems or entities. An arrow indicates a data flow. In this example, the emergency response system 900 is the emergency response system according to the second embodiment of the present invention. Below, the emergency response system 900 will be described by explaining the data flow when an emergency incident occurs.

As shown by block 1101, when an emergency incident occurs in the airport, the call center 910 receives an emergency call as indicated by block 1111. The call center dispatcher will then enter the call details as shown by block 1112. When the call center is connected with an existing CAD 1140, the call details will be transmitted to CAD. The emergency response system 900 is compatible with the existing CAD 1140 and receives the call details from CAD 1140 as an incident information 1102. In addition, the emergency response system 900 may also connected to the call center 1111 bypassing CAD 1140. The call center 1110 may also push the call details directly to the emergency response system 900 as an incident information 1102 that intrigues the emergency response system 900 to automatically start an emergency response and run routines such as data fusion routine. Block 1113 illustrates a traditional and optional way in which the call center dispatcher may manually notify relevant units through radio or phone calls.

Upon receipt of an incident information 1102, the emergency response system 900 automatically activates the data fusion module 1131 to run the routine as shown in FIG. 5. Specifically, the data fusion module 1131 sends a notification to each relevant user's device such as a mobile phone or tablet of a first responder, and a department computer of an officer or dispatcher. In addition, the data fusion module 931 may also retrieve the status of the related first responders before sending the notification. For example, if some of the related first responders are off duty, the data fusion module 931 will not send the notification to their devices. As aforementioned, the notification also includes options for the first responders to choose their action, such as going to the scene, going to the station, standby, or unavailable. The choice, that is, the user response, as a type of user data 1142, will be sent back to the data fusion module 1131 as one of the live data streams. When a first responder chooses to go to the scene or the station or to standby, additional user data 1142, including the location of the first responders, and data from the Iot sensors equipped or worn on the first responders, if any, will also be fed to the data fusion module 1131 as part of the live data streams 1150. The sensors may include but not limited to, temperature sensor, camera, thermal camera, CO 2 sensor, and so on.

The data fusion module 1131 generates and provides an incident dashboard to department devices and relevant first responder's mobile devices as aforementioned by referring to FIGS. 5 and 7. The live incident dashboard presents a map with related information. As shown by FIG. 7, the live location of the incident, pre-plan information (location of hydrants, hazmat, etc.), the location of responders and vehicles (such as ambulance and fire truck) are marked on the map. The data fusion module 1131 also obtains other live data streams 1150 and makes them available on the incident dashboard, such as Closed Circuit Television (CCTV) feeds around the incident scene, video, audio and other output data from the sensors equipped on the first responders and vehicles, video feeds from drones. For example, the user may access those data by click or touch corresponding icons and buttons on the incident dashboard.

As shown by arrow 1161, as a part of the emergency response system 900, the call center dispatcher, during an emergency call, may also request authorization of the caller to upload live video if the caller has a mobile device with camera. If the caller agrees, the call center dispatcher may then send, through the emergency response system 900, a text message with a webpage link to the caller's mobile device. By clicking on the link, the caller will be prompted to feed live video preferably through browser on their mobile device without having to downloading an application. In another embodiment, the link may also lead the caller to download an application to feed live video to the data fusion module 1131. The data fusion module 1131 may then provide the live video feed from the call to the live incident dashboard on relevant user's devices. In addition, as shown by arrow 1162, during the life span of an emergency incident, if a department officer or a first responder deems it necessary, the data fusion module 1131 may also be instructed to send a text message to the caller even after the caller has hung up the phone call with the call center 1110. The text message contains a webpage link to obtain the caller's authorization and then allows the caller to upload live video of the scene.

The emergency response system 1130 further includes other modules 1132 such as the post incident report module, archive management module, and user management module as aforementioned by referring to FIG. 4. Based on the function and API of the existing CAD 1140, the emergency response system 900 also exchange data related to the incident back and forth with CAD 1140 as indicated by the arrow 1181. This provides a two-way integration and communication between the emergency response system 900 and the CAD 1140. For example, during the lifetime of an incident, when an update on the incident arrives at either one of the emergency response system 900 and the CAD 1140, the other may track and obtain the update through the two-way communication and integration. Some of the live data streams may be fed to the CAD 1140, and the emergency response system may then obtain these live data streams from the CAD 1140, and vice versa. When information and data streams are fed to both of the emergency response system 900 and the CAD 1140, the two-way communication also allows the emergency response system 900 and the CAD 1140 to track when resources arrive and verify the resources with each other. In another example, an existing CAD 1140 may require a feedback if related departments, units and first responders have received and responded to the incident information. The emergency response system 900 may provide such information to CAD 1140 when receiving the response from the first responder's devices or confirmation from department devices. In addition, when CAD 1140 requires an incident report after it has been handled, the emergency response system 900 may also generate an incident report with all the information required and feed the report to CAD 1140 through, for example, post incident report module as described in the first embodiment.

As shown by arrow 1183, department or dispatcher 1120 may also send an incident information 1102 to the emergency response system 900 without going through the call center 1110 or CAD 1140. This is usually used when a test or response drill is intended. In a rare situation, it may also trigger an emergency response in the emergency response system 900 to a real emergency incident, when the department or dispatcher learns that an incident occurs or when the call center 1110, CAD 1140, or the connection between the call center 1110 or CAD 1140 and the emergency response system 900 malfunctions.

Therefore, as can be understood from the aforementioned description, by applying the emergency response system to an airport emergency response network, it may connect first responders to critical information on their devices especially their cell phones and tablets before they arrive on scene. The data fusion module works by combining and sharing multiple information streams in real-time including but not limited to CAD, building floor plans, personnel locations, live video feed from drones and CCTV, and weather information. The data fusion module may also have API that may be potentially connected to other data/information sources. data fusion & common operating module sends instant notifications with customized response dashboards, to help first responders receive information promptly, make informed decisions, and arrive on-scene faster. By providing channel for callers and other individuals to allow the platform the access of their mobile devices, emergency scene can be directly broadcasted to the platform. The 911 caller would not be required to download an app, they would simply receive a non-intrusive text message asking to allow or deny access while still on the phone with the 911 operator. Along with live video, passengers could provide audio, text, or images.

In addition, by making the emergency response system compatible with existing CAD systems, the emergency response system may be implemented with minimal impact to existing systems and workflows. By connecting to API of existing CAD system and call center systems or making minimal changes to existing CAD system and call center, the emergency response system according to the present invention may function upon receiving the incident information. In this case, the user interface at the call center does not have to change and thus the call center dispatchers do not have to change their workflows.

Furthermore, by sending messages to mobile phones around the airport and presenting the emergency information on signages in real time, the emergency information can be promptly and efficiently delivered to the public and thus make travelers and airport employees feel safer and more secure.

As can be understood, the emergency response system may function well without the CAD system. In addition, in the case that both CAD and the emergency response system are implemented, the addition of emergency response system provide a more reliable system with improved fail safe.

As can be understood, the emergency response system 900 may also be applied to emergency response networks in other public areas such as train station, theater, and stadium, among others.

### Third Embodiment

FIG. 10 depicts a data flow chart of an emergency response system according to the third embodiment of the present invention that is applied to a general emergency response network, for example, a municipal public safety department. The emergency response network may overlook a specific area, which may in turn be a neighborhood, a town, a city, or even a greater metropolitan area.

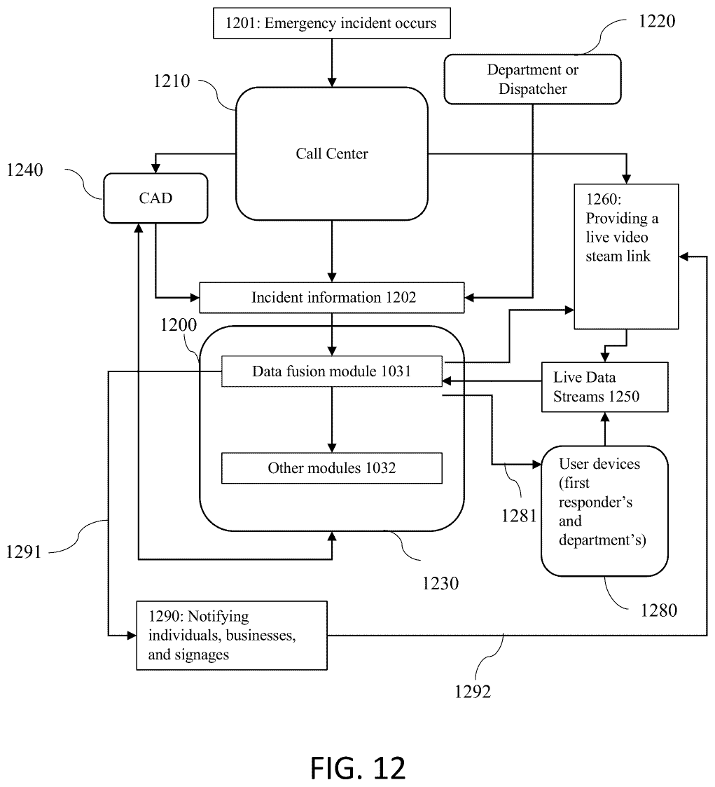

The data flow in the third embodiment is basically similar to that of the second embodiment. As shown by FIG. 12, the data flow chart includes a call center 1210, a department/dispatcher 1220, an emergency response system 1200, and a CAD 1230 that are similar or same in structure and function to the call center 1110, department/dispatcher 1120, emergency response system 900, and CAD 1130 in the second embodiment. Therefore, the relevant annotations in FIG. 12 are simplified and relevant description about the same data flow will be omitted. For example, the steps of sending notification and providing an incident dashboard are simplified into a data flow arrow 1281 between the data fusion module 1231 and the user devices 1280.

Different from the second embodiment, in the event when the emergency response system 1200 receives an incident information 1202, the data fusion module 1231 may intelligently send the notification to relevant user's devices based on location and type of the incident. For example, if the incident notice reports a fire, the notification will be pushed to the user devices of related fire department or fire station that is close to the scene and to the mobile devices of related fire fighters. If the incident notice reports a violent incident, the notification will be pushed to police station and police officers that is close to the scene in addition to first-aid personnel.

Different from the second embodiment, the emergency response system 1200 may further include mutual aid module, as described in the first embodiment, which allows the emergency response system 1200 to exchange data with other emergency response networks.

As shown by arrow 1291 in FIG. 12, when the emergency response system 1030 receives an incident information 1202, the data fusion module 1231 sends notifications to individuals and businesses around the incident scene as indicated by the arrow 1291. For example, the emergency response system 1030 may send the incident information to mobile base stations around the incident scene, the mobile base stations will then broadcast the information as text messages to all the mobiles that are currently connected to the base stations. Therefore, all the individuals with a mobile phone will be receiving the notification and alerted about the incident. Businesses may be notified through the same way if they have a mobile phone. In another embodiment, businesses may also be required to register through an application or web browser on their devices such as computers, tablets, and mobile phones, the notification will be pushed to their registered devices. In addition, when the emergency response system 1200 according to the third embodiment sends notification to individuals and businesses around the incident scene, the notification may be sent through the mobile base stations that are close to the scene within a predetermined range, for example, 1 mile or 2 miles. In some embodiment, the range can be determined based on the nature and status of the incident by the emergency response system 1200. Furthermore, the relevant information may be sent to and present on signages such as electronic billboards around the scene.

As indicated by arrow 1092, a text message with a link may also be sent to the mobile phones. Individuals may choose to feed live video steam from their mobile devices with a camera to the data fusion module 1031 as a part of the live data streams 1050. It is similar to request the caller to feed live video steam as aforementioned in the second embodiment. This function may be initiated under authorization from department's devices or first responder's devices. In addition, or alternatively, this function may also be initiated by the emergency response system 1200 based on the type and situation of the incident. For example, when the incident is a fire or of other types that may harm the bystanders, the bystanders should be encouraged to leave the scene, such request to feed live video stream will not be sent.

The emergency response system 1200 according to the third embodiment provides similar advantages as those provided by the second embodiment. In addition, it also makes it easier and more efficient to notify individuals and businesses around the incident scene.

While the foregoing specification has been described with regard to certain preferred embodiments, and many details have been set forth for the purpose of illustration, it will be apparent to those skilled in the art without departing from the spirit and scope of the invention, that the invention may be subject to various modifications and additional embodiments, and that certain of the details described herein can be varied considerably without departing from the basic principles of the invention. Such modifications and additional embodiments are also intended to fall within the scope of the appended claims.

What is claimed:

1. An emergency response method, implemented by at least one computing system, comprising:
providing on a user device of a first responder, a map that at least include the location of an emergency incident;
marking on the map, location of the incident, location of the first responder, and pre-plan information; and
receiving a live data stream and providing the live data steam on the user device of the first responder.

2. The emergency response method of claim 1, wherein the pre-plan information includes at least one from the group consisting of: location of hydrants, location of hazmat, and floor plan of buildings.

3. The emergency response method of claim 1, wherein the live data stream comprises at least one from the group consisting of: weather information, video feed from a camera in CCTV, video feed from a drone, output from a senor equipped with the first responder, location of other responder, location of an emergency vehicle.

4. The emergency response method of claim 1, further comprising:
receiving an incident information indicating an occurrence of the emergency incident;
sending a notification to the first responder's device about the occurrence of the emergency incident;
receiving a response from the mobile device indicating if the first responder is available.

5. The emergency response method of claim 1, wherein
the incident information is entered by an emergency call center when receiving an emergency call from a caller; and
the emergency response method further comprises:
sending a text message to the caller's device with a webpage link to upload caller video feed;
receiving the caller video feed from the caller's device the video feed; and
providing the caller video feed as a part of the live data stream.

6. The emergency response method of claim 1, further comprises: broadcasting a message with information about the incident to all cell phones near a location of the emergency incident.

7. The emergency response method of claim 1, further comprising: presenting a message with information about the incident to a signage near a location of the incident.

8. The emergency response method of claim 1, further comprising: providing navigation and routing to the location of the incident on the map.

9. The emergency response method of claim 1, further comprising: providing a control panel to control a drone to approach a location of the incident if the drone is available.

10. An emergency response system comprising:
a computing device connected to a network; and
a user device connected to the network;
wherein the computing device comprises at least one processor and memory coupled to the at least one processor, the memory comprising computer executable instructions that, when executed by the at least one processor, performs a method comprising:
providing on the user device of a first responder, a map that at least include the location of an emergency incident;
marking on the map, location of the incident, location of the first responder, and pre-plan information; and
receiving a live data stream and providing the live data steam on the user device of the first responder.

11. The emergency response system of claim 10, wherein the pre-plan information includes at least one from the group consisting of: location of hydrants, location of hazmat, and floor plan of buildings.

12. The emergency response system of claim 10, wherein the live data stream comprises at least one from the group consisting of: weather information, video feed from a camera in CCTV, video feed from a drone, output from a senor equipped with the first responder, location of other responder, location of an emergency vehicle.

13. The emergency response method of claim 1, wherein the method further comprises:
receiving an incident information indicating an occurrence of the emergency incident;
sending a notification to the first responder's device about the occurrence of the emergency incident;
receiving a response from the mobile device indicating if the first responder is available.

14. The emergency response system of claim 10, wherein
the incident information is entered by an emergency call center when receiving an emergency call from a caller; and
the method further comprises:
sending a text message to the caller's device with a webpage link to upload caller video feed;
receiving the caller video feed from the caller's device the video feed; and
providing the caller video feed as a part of the live data stream.

15. The emergency response system of claim 10, wherein the method further comprises: broadcasting a message with information about the incident to all cell phones near a location of the emergency incident.

16. The emergency response system of claim 10, wherein the method further comprises: providing navigation and routing to the location of the incident on the map.

17. The emergency response system of claim 10, wherein the method further comprises: providing a control panel to control a drone to approach a location of the incident if the drone is available.
